(19) United States
(12) Patent Application Publication
(10) Pub. No.: US 2025/0256289 A1
(43) Pub. Date: Aug. 14, 2025

(54) DUST COLLECTION SYSTEM AND DUST COLLECTION METHOD

(71) Applicant: MITSUBISHI HEAVY INDUSTRIES, LTD., Tokyo (JP)

(72) Inventors: Nobuki UDA, Tokyo (JP); Yasutoshi UEDA, Tokyo (JP)

(73) Assignee: MITSUBISHI HEAVY INDUSTRIES, LTD., Tokyo (JP)

(21) Appl. No.: 18/724,358

(22) PCT Filed: Mar. 9, 2023
(86) PCT No.: PCT/JP2023/009088

§ 371 Date: Jun. 26, 2024

(30) Foreign Application Priority Data
Apr. 15, 2022 (JP) 2022-067895

(51) Int. Cl. B03C 3/41; B03C 3/014; B03C 3/017; B03C 3/16

(52) U.S. Cl. CPC B03C 3/41; B03C 3/014; B03C 3/0175; B03C 3/16

(57) ABSTRACT

Provided are a dust collection system and a dust collection method that make it possible to efficiently collect fine particles included in a gas. The dust collection system includes: a flow path route through which a gas flows; a droplet supply section for supplying droplets to the flow path route; an electrostatic agglomeration unit that is arranged in the flow path route downstream from the position at which droplets are supplied, forms an electric field in the flow path of the gas, electrostatically charges the droplets and fine particles included in the gas, and causes the fine particles and the droplets to collide (agglomerate); and a dust collection section t is arranged in the flow path route downstream from the electrostatic agglomeration unit and collects the droplets and fine particles.

### TECHNICAL FIELD

The present disclosure relates to a dust collection system and a dust collection method.

### BACKGROUND ART

In a power plant that combusts fossil fuel or a waste treatment plant that combusts waste, a dust collection system that collects fine particles contained in exhaust gas is disposed as an exhaust gas treatment device. Examples of the dust collection system include an electric dust collector that forms an electric field in a passage of exhaust gas to collect charged fine particles by causing the fine particles to adhere to an electrode, a wet type dust collector that sprays droplets into the exhaust gas to collect the fine particles with the droplets, and a cyclone type dust collector that rotates the exhaust gas to perform centrifugal separation of the fine particles. For example, PTL 1 and PTL 2 describe a system in which droplets are sprayed by a spray on an upstream side of an electric dust collector.

### CITATION LIST

### Patent Literature

[PTL 1] International Publication No. WO2011/108324
[PTL 2] International Publication No. WO2016/153046

### SUMMARY OF INVENTION

### Technical Problem

As in PTL 1 and PTL 2, the water can be caused to adhere to the fine particles by spraying the water into the exhaust gas, and the fine particles can be collected by electric dust collector on the downstream. However, more efficient collection is required.

The present disclosure has been made in view of such problems, and an object of the present disclosure is to provide a dust collection system and a dust collection method capable of efficiently collecting fine particles contained in a gas.

### Solution to Problem

A dust collection system of the present disclosure for solving the above problems includes a circulation passage through which a gas circulates; a droplet supply unit that supplies circulation passage; an droplets to the electrostatic flocculation unit that is disposed in the circulation passage on a downstream side from a supply position of the droplets, forms an electric field in a flow path of the gas, and charges fine particles contained in the gas and the droplets to collide (flocculate) with each other; and a dust collection unit that is disposed in the circulation passage on a downstream side from the electrostatic flocculation unit and collects the droplets and the fine particles.

A dust collection method of the present disclosure for solving the above problems includes a step of supplying droplets to a circulation passage through which a gas circulates; a step of forming an electric field in the circulation passage on a downstream side from a supply position of the droplets, and charging fine particles contained in the gas and the droplets to collide (flocculate) with each other; and a step of collecting the droplets and the fine particles in the circulation passage on a downstream side from a position where the fine particles and the droplets are charged.

### Advantageous Effects of Invention

According to the present disclosure, the fine particles contained in the gas can be efficiently collected.

### BRIEF DESCRIPTION OF DRAWINGS

FIG. 1 is a schematic diagram showing a schematic configuration of a combustion plant having a dust collection system according to the present embodiment.

FIG. 2 is a perspective view showing a schematic configuration of the dust collection system.

FIG. 3 is a cross-sectional view showing a schematic configuration of the dust collection system shown in FIG. 2.

FIG. 4 is a view for describing a process of the dust collection system.

FIG. 5 is a view for describing a process of the dust collection system.

FIG. 6 is a perspective view showing a schematic configuration of a dust collection system according to another embodiment.

FIG. 7 is a cross-sectional view showing a schematic configuration of the dust collection system shown in FIG. 6.

FIG. 8 is a perspective view showing a schematic configuration of a dust collection system according to another embodiment.

FIG. 9 is a perspective view showing a schematic configuration of a dust collection system according to another embodiment.

FIG. 10 is a perspective view showing a schematic configuration of a dust collection system according to another embodiment.

### DESCRIPTION OF EMBODIMENTS

Hereinafter, a dust collection system and a dust collection method according to the present disclosure will be described with reference to the drawings. It should be noted that the present disclosure describes an embodiment of the present invention, and the present invention is not limited thereto. The present embodiment will describe the dust collection system as a case of processing the exhaust gas combusted by the combustion device. However, the present embodiment is not limited thereto. The dust collection system can be used to collect various fine particles contained in a gas. For example, the dust collection system can be used as a system for recovering fine particles contained in air in a manufacturing plant or a system for recovering fine particles, for example, dust in a work site such as a demolition work site. In addition, the fine particles are not limited to the solid, and may be a liquid such as a droplet or tar.

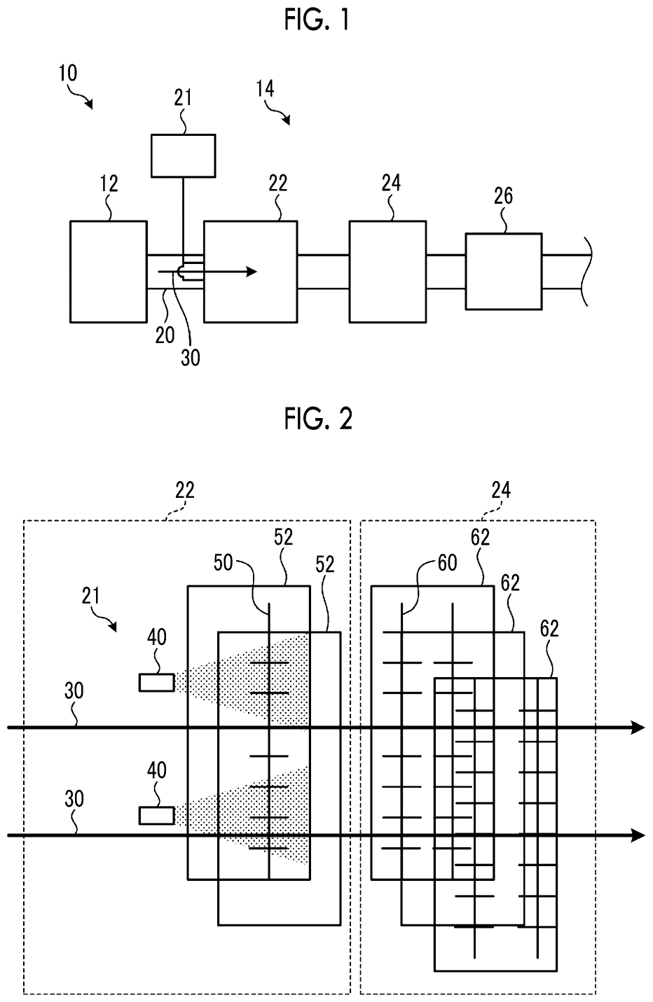

FIG. 1 is a schematic diagram showing a schematic configuration of a combustion plant having a dust collection system according to the present embodiment. A combustion plant 10 shown in FIG. 1 includes a combustion device 12 and a dust collection system 14.

The combustion device 12 is a device that combusts fossil fuel, incineration object, or the like. The combustion device 12 discharges the exhaust gas generated during combustion. The heat generated by combusting the target contained in the exhaust gas can be used as a power generation or a heat source. In the combustion plant 10, an exhaust heat recovery device that recovers heat of the exhaust gas or an exhaust gas treatment device that treats a harmful component other than fine particles may be disposed in the passage of the exhaust gas.

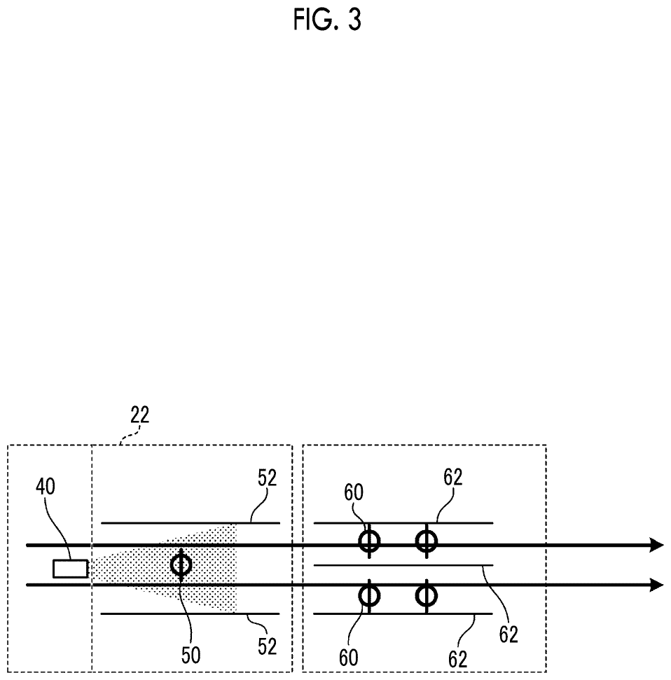

Next, the dust collection system 14 will be described with reference to FIGS. 1, 2, and 3. FIG. 2 is a perspective view showing a schematic configuration of the dust collection system. FIG. 3 is a cross-sectional view showing a schematic configuration of the dust collection system shown in FIG. 2. The dust collection system 14 collects fine particles contained in the exhaust gas discharged from the combustion device 12. The dust collection system 14 includes a circulation passage 20, a droplet supply unit 21, an electrostatic flocculation unit 22, an electric dust collector 24, and a blower 26. The circulation flow path 20 is a pipeline through which the exhaust gas generated by the combustion device 12 flows in the circulation direction 30. The circulation flow path 20 is disposed in the droplet supply unit 21, the electrostatic flocculation unit 22, the electric dust collector 24, and the blower 26 in this order from the upstream side in the circulation direction 30.

The droplet supply unit 21 sprays a liquid into the circulation flow path 20 to form a large number of droplets. The droplet supply unit 21 includes a plurality of nozzles 40. The nozzle 40 sprays a liquid to form droplets having a particle size in a predetermined range.

The electrostatic flocculation unit 22 is disposed on a downstream side from the nozzle 40 of the droplet supply unit 21 of the circulation flow path 20. The electrostatic flocculation unit 22 forms an electric field in a region through which the fine particles and the droplets pass, and charges the fine particles and the droplets. The charged fine particles and the droplets move in the electric field by diffusion and electrophoresis to collide (flocculate) with each other. When the fine particles collide with the droplets, the fine particles are taken into the droplets. The electrostatic flocculation unit 22 has a discharge electrode 50 and a ground electrode 52. A predetermined voltage is applied to the discharge electrode 50. The ground electrode 52 is a plate-shaped electrode disposed to face the discharge electrode 50. The ground electrode 52 is disposed such that a direction along the circulation direction 30 is a surface. Accordingly, the ground electrode 52 can be suppressed from becoming a resistance to the flow of the exhaust gas. The ground electrode 52 is grounded. The electrostatic flocculation unit 22 applies a predetermined voltage to the discharge electrode 50 to form an electric field between the discharge electrode 50 and the ground electrode 52. The electrostatic flocculation unit 22 may form an electric field between the discharge electrode 50 and the ground electrode 52, and a predetermined voltage may be applied without grounding the ground electrode 52.

In the present embodiment, the electrostatic flocculation unit 22 is disposed on the downstream side of the nozzle 40. However, the present disclosure is not limited thereto. A part of the electrostatic flocculation unit 22 may be disposed on the upstream side of the nozzle 40. That is, the nozzle 40 may be disposed in the electrostatic flocculation unit 22.

The electric dust collector 24 is disposed on a downstream side from the electrostatic flocculation unit 22 of the circulation flow path 20. The electric dust collector 24 forms an electric field in a region through which the fine particles and the droplets pass, and collects the fine particles and the droplets. The electric dust collector 24 has a discharge electrode 60 and a ground electrode (collection electrode) 62. A predetermined voltage is applied to the discharge electrode 60. The ground electrode 62 is a plate-shaped electrode disposed to face the discharge electrode 60. The ground electrode 62 is disposed such that a direction along the circulation direction 30 is a surface. Accordingly, the ground electrode 62 can be suppressed from becoming a resistance to the flow of the exhaust gas. The ground electrode 62 is grounded. In the electric dust collector 24 of the present embodiment, the discharge electrode 60 and the ground electrode (collection electrode) 62 are disposed at an interval shorter than the interval between the discharge electrode 50 and the ground electrode 52 of the electrostatic flocculation unit 22. The electric dust collector 24 applies a predetermined voltage to the discharge electrode 60 to form an electric field between the discharge electrode 60 and the ground electrode 62. The electric dust collector 24 forms an electric field to move the fine particles contained in the exhaust gas and the droplets toward the ground electrode 62 and collects the fine particles and the droplets by adhering the fine particles and the droplets to the ground electrode 62.

The electric dust collector 24 may form an electric field between the discharge electrode 60 and the ground electrode 62, and may apply a predetermined voltage without grounding the ground electrode 62. The electric dust collector 24 may include a washing device that removes fine particles adhering to the ground electrode 62 or a recovery device that drops the fine particles in a vertical direction and recovers the fine particles.

The blower 26 is disposed in the circulation flow path 20 on a downstream side from the electric dust collector 24. The blower 26 forms a flow directed from the combustion device 12 toward the electric dust collector 24 and sends the exhaust gas in the circulation direction 30. In a case where the exhaust gas from the combustion device 12 or the like is discharged at a predetermined flow velocity, the dust collection system 14 may not be provided with the blower 26. That is, the combustion device 12 may satisfy the blowing function.

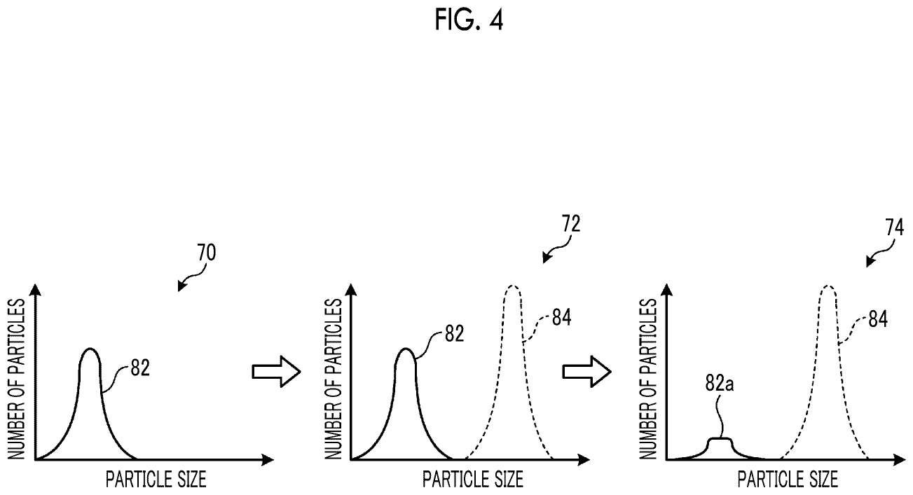

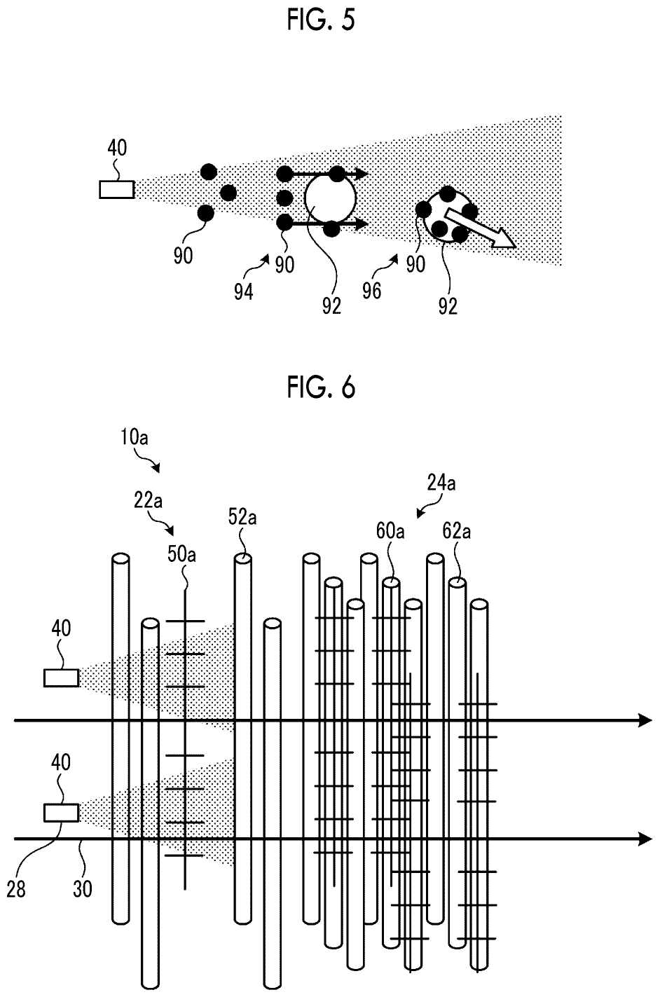

Next, a dust collection method of the dust collection system 14 will be described with reference to FIGS. 4 and 5 in addition to FIGS. 2 and 3. Each of FIGS. 4 and 5 is a view for describing a process of the dust collection system. The exhaust gas containing fine particles is supplied to the dust collection system 14. As shown in a particle distribution 70 in FIG. 4, the distribution of the particles contained in the gas flowing into the dust collection system 14 is only a fine particle distribution 82 corresponding to the fine particles.

The exhaust gas flowing into the dust collection system 14 moves along the circulation direction 30, and the droplets are supplied in a region where the nozzle 40 is disposed. As shown in a particle distribution 72 in FIG. 4, the distribution of the particles contained in the gas to which the droplets are supplied includes a fine particle distribution 82 corresponding to the fine particles and a droplet distribution 84 corresponding to the droplets. That is, a state where the droplets and the fine particles are mixed is formed.

In the dust collection system 14, when the gas in which the droplets and the fine particles are mixed passes through the electrostatic flocculation unit 22, the fine particles 90 and the droplets 92 pass through the first region 94 in which an electric field is formed, as shown in FIG. 5. The fine particles 90 and the droplets 92 are charged when passing through the first region 94 where the electrostatic flocculation unit 22 is disposed. When the fine particles 90 approach a vicinity of the droplets 92 in a charged state, the fine particles 90 adhere to the droplets 92 or are absorbed into the droplets. Accordingly, as shown in FIG. 4, in the dust collection system 14, the particle distribution 74 of the gas that has passed through the electrostatic flocculation unit 22 becomes the fine particle distribution 82a and the droplet distribution 84. Here, the fine particle distribution 82a is decreased from the fine particle distribution 82 for fine particles to integrate with the droplets.

In the dust collection system 14, the gas in the state of the particle distribution 74 passes through a second region 96 where the electric dust collector 24 is disposed. The droplets 92 to which the fine particles 90 passing through the second region 96 is adhered is subjected to a force which moves toward the ground electrode 62 in an electric field formed in the electric dust collector 24, moves toward the ground electrode 62, and adheres to the ground electrode 62.

As described above, the dust collection system 14 is provided with the droplet supply unit 21 and the electrostatic flocculation unit 22 on the upstream side of the electric dust collector 24. The droplet supply unit 21 supplies the droplets to the exhaust gas, and the electrostatic flocculation unit 22 charges the droplets and the fine particles. In this manner, the droplets and the fine particles are easily brought into collision with each other, and the fine particles can be collected by the droplets. The droplets that collect fine particles can be collected by the electric dust collector 24, so that the fine particles in the exhaust gas can be collected.

In a case where the droplets and the fine particles are not charged, the fine particles are not brought close to the droplets due to the influence of a gas flow around the droplets generated by moving along the flow of the exhaust gas, and the fine particles are less likely to come into contact with the droplets. When the droplets and the fine particles reach the electric dust collector 24 in this state, the droplets and the fine particles are in separate states, and the electric dust collector 24 collects the droplets to which the fine particles are not adhered. In contrast, the droplets and the fine particles are charged by the electrostatic flocculation unit 22, as described above, whereby the fine particles can be easily caused to collide with the droplets, and the fine particles can adhere to the droplets before reaching the electric dust collector 24. Accordingly, the droplets in which the fine particles are collected can be collected by the electric dust collector 24.

In the dust collection system 14, the droplets that are easier to move than the fine particles in the same electric field can be collected by collecting the droplets to which the fine particles adhere by the electric dust collector 24, and can be collected the droplets more efficiently than collecting the fine particles alone. In addition, since the droplets can be collected at a distance shorter than that of the fine particles, the size of the electric dust collector 24 can be reduced.

Here, it is preferable that the electrostatic flocculation unit 22 forms an electric field having a lower electric field strength than that of the electric dust collector 24. Accordingly, in the electrostatic flocculation unit 22, the fine particles and the droplets can be brought into contact with each other while the collection of the droplets is suppressed, and the droplets can be collected by the electric dust collector 24.

It is preferable that the electrostatic flocculation unit 22 has a distance between the ground electrode and the discharge electrode larger than that of the electric dust collector 24. It is preferable that the electrostatic flocculation unit 22 has a distance between the ground electrode and the discharge electrode equal to or more than 2 times and equal to or less than 3 times with respect to the electric dust collector 24.

It is preferable that the electrostatic flocculation unit 22 has a potential difference between the ground electrode and the discharge electrode smaller than that of the electric dust collector 24. It is preferable that the electrostatic flocculation unit 22 has a potential difference between the ground electrode and the discharge electrode equal to or larger than ⅓ and equal to or smaller than 1 with respect to the electric dust collector 24. The electrostatic flocculation unit 22 can charge the droplets and the fine particles while suppressing the occurrence of discharge via the droplets between the ground electrode and the discharge electrode by making the potential difference between the ground electrode and the discharge electrode smaller than that of the electric dust collector 24.

It is preferable that the electrode interval (the interval in the gas flow direction or the distance in the direction perpendicular thereto) between the discharge electrode and the ground electrode of the electrostatic flocculation unit 22 is 100 mm or more and 500 mm or less. It is preferable that the potential difference between the discharge electrode and the ground electrode of the electrostatic flocculation unit 22 is 10 kV or more and 50 kV or less. By increasing the electrode interval in the gas flow direction, it is possible to secure a collision time between the fine particles and the droplets.

It is preferable that the droplet supply unit 21 supplies, to the circulation flow path 30, the droplets in which a relationship between a flow rate α (L/min) of the droplets to be supplied and a gas flow rate β (m³/min) of the circulation flow path 30 satisfies 0.1≤(α/β)≤1.0. Accordingly, the droplets and the fine particles can be charged while suppressing the occurrence of abnormal discharge (spark) via the droplets between the ground electrode and the discharge electrode.

The electrostatic flocculation unit 22 and the electric dust collector 24 may be disposed inside one housing. For example, the electrostatic flocculation unit 22 and the electric dust collector 24 may be configured such that an electrode for forming an electric field is disposed in the circulation flow path 20. In addition, the dust collection system 14 may be provided with a predetermined distance between the electrostatic flocculation unit 22 and the electric dust collector 24. In this manner, the fine particles charged by the electrostatic flocculation unit 22 can enter the electric dust collector 24 in a state of being adhered to the droplets, and thus the efficiency of collecting the fine particles can be further improved.

In the dust collection system 14 of the present embodiment, the dust is collected by the electric dust collector 24, so that the charged droplets and the fine particles can be efficiently moved, and the fine particles can be efficiently collected. Here, since the dust collection system 14 of the present embodiment can obtain the above-described effect, the droplets and the fine particles are collected by the electric dust collector 24. However, the dust collection unit is not limited thereto. In dust collection system 14, as the dust collection unit, a cyclone type dust collector that collects that rotates a gas in a centrifugal direction to collect the droplets by using a centrifugal force may be used, a mist trap that collects the droplets may be provided, or a wet type dust collector that supplies droplets, combines the droplets with the adhered fine particles, and drops the droplets is provided may be used.

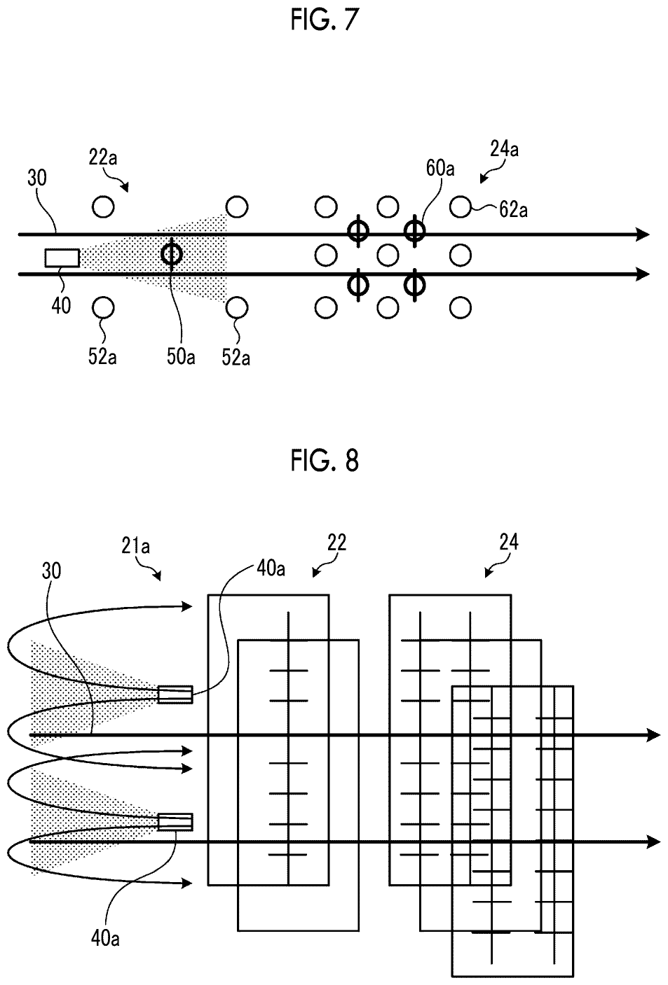

FIG. 6 is a perspective view showing a schematic configuration of a dust collection system according to another embodiment. FIG. 7 is a cross-sectional view showing a schematic configuration of the dust collection system shown in FIG. 6. The dust collection system shown in FIGS. 6 and 7 is the same as the dust collection system 14 except for the structure of the electrostatic flocculation unit 22a and the electric dust collector 24a.

The electrostatic flocculation unit 22a has a discharge electrode 50a and a ground electrode 52a. The discharge electrode 50a is a rod-shaped electrode. The ground electrode 52 is a rod-shaped electrode and is disposed around the discharge electrode 50a. The electric dust collector 24a has a discharge electrode 60a and a ground electrode 62a. The discharge electrode 60a is a rod-shaped electrode. The ground electrode 62 is a rod-shaped electrode and is disposed around the discharge electrode 60a. In a case where a plurality of the discharge electrodes 60a are disposed around the ground electrode 62, the ground electrode 62 is disposed to be at an equal distance from each of the plurality of discharge electrodes 60a.

As described above, the ground electrodes 52a and 62a may have a rod-like shape. Also in this case, by setting the electric field of the electrostatic flocculation unit 22a to a lower electric field strength than the electric field of the electric dust collector 24a, the droplets and the fine particles are charged in the electrostatic flocculation unit 22a, and the droplets containing the fine particles can be easily collected by the electric dust collector 24a by colliding (flocculating) the droplets and fine particles.

FIG. 8 is a perspective view showing a schematic configuration of a dust collection system according to another embodiment. In the dust collection system shown in FIG. 8, the droplet supply unit 21a is different from the dust collection system 14. Hereinafter, specific points of the dust collection system shown in FIG. 8 will be described. In the droplet supply unit 21a of the dust collection system shown in FIG. 8, the spraying direction of the nozzle 40a is opposite to the circulation direction 30. That is, the nozzle 40a sprays the droplets toward the upstream side in the circulation direction 30. Accordingly, after the sprayed droplets move to the upstream side in the circulation direction 30, the advancing direction of the droplets is reversed by the force of the exhaust gas flowing along the circulation direction 30, and the droplets move along the circulation direction 30.

In the dust collection system shown in FIG. 8, the spray port of the nozzle 40a is disposed on the upstream side in the circulation direction 30, and the droplets are sprayed toward the upstream side in the circulation direction 30. In this manner, the distance that the droplets sprayed from the nozzle 40a move until the droplets enter the electrostatic flocculation unit 22 can be made longer. Accordingly, the droplets supplied from the droplet supply unit 21a can be caused to enter the electrostatic flocculation unit 22 in a more dispersed state. The dispersed droplets enter the electrostatic flocculation unit 22, so that the fine particles and the droplets can be brought into close contact with each other. In addition, even when the distance between the nozzle 40a and the electrostatic flocculation unit 22 shortened, the droplets can move by a distance necessary for the droplets to be dispersed. Therefore, the performance of collecting the fine particles can be improved while the size of the dust collection system in the circulation direction 30 is shortened.

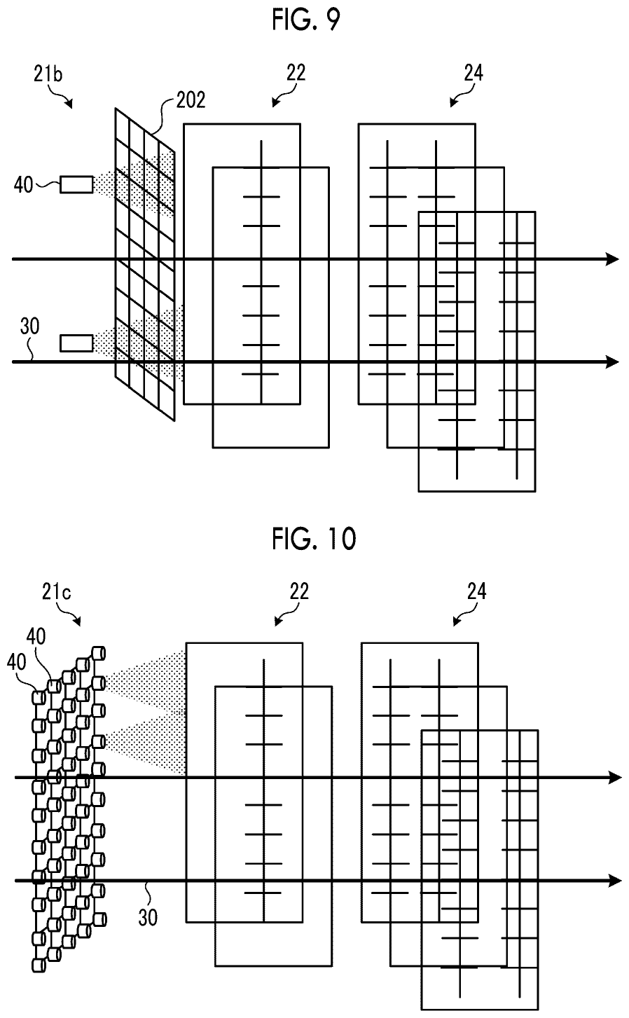

FIG. 9 is a perspective view showing a schematic configuration of a dust collection system according to another embodiment. In the dust collection system shown in FIG. 9, the droplet supply unit 21b is different from the dust collection system 14. Hereinafter, specific points of the dust collection system shown in FIG. 9 will be described. The droplet supply unit 21b of the dust collection system shown in FIG. 9 includes the rectification mechanism 202 in addition to each portion of the droplet supply unit 21.

The rectification mechanism 202 is disposed between the nozzle 40 and the electrostatic flocculation unit 22. The rectification mechanism 202 is a mesh disposed in a plate like, so-called plate shape, in which an opening through which the droplets and the fine particles pass is regularly formed. For example, the rectification mechanism 202 can use a mesh having an opening ratio of 0.5. It is preferable that the rectification mechanism 202 has an opening ratio of the mesh of 0.2 or more and 0.6 or less.

The droplet supply unit 21b disposes the rectification mechanism 202 in which the openings are regularly formed between the nozzle 40 and the electrostatic flocculation unit 22, so that the flow of the droplets sprayed from the nozzle 40 and the fine particles contained in the exhaust gas is rectified, and the fine particles are easily caused to collide with the droplets. Specifically, in the rectification mechanism 202, a region through which the droplets and the fine particles can pass can be constrained to the opening of the rectification mechanism 202. Accordingly, at the time of passing through the opening, the droplets can be in a state of being in the vicinity of the fine particles, and the fine particles can be easily caused to collide with the droplets. In addition, the droplets can be dispersed over a wide range of the rectification mechanism 202 by uniformly spreading the droplets on the mesh surface. As a result, the droplets and the fine particles can be brought into contact with each other over a wider range.

The rectification mechanism 202 is not limited to the mesh-shaped plate, and may have various shapes that are capable of restricting the movement of the droplets and the fine particles sprayed from the nozzle 40 and promoting the adhesion of the fine particles to the droplets. The rectification mechanism 202 may have a structure in which tubular flow paths are two-dimensionally arranged, that is, a structure in which a thick mesh is disposed. In addition, a plurality of stages of the rectification mechanism 202 may be installed.

FIG. 10 is a perspective view showing a schematic configuration of a dust collection system according to another embodiment. In the dust collection system shown in FIG. 10, the droplet supply unit 21c is different from the dust collection system 14. Hereinafter, specific points of the dust collection system shown in FIG. 10 will be described. In the droplet supply unit 21c of the dust collection system shown in FIG. 10, the nozzles 40 are disposed in a lattice pattern. For example, the droplet supply unit 21c disposes 60 nozzles 40 per 1 m².

The droplet supply unit 21c disposes the nozzles 40 in a lattice pattern. Accordingly, a region where the droplets are sprayed by one nozzle 40 can be reduced, and a distance (a distance in the circulation direction 30) required for the sprayed droplets to diffuse to a predetermined range can be shortened. In addition, the droplets are sprayed from the plurality of nozzles disposed in a lattice pattern, so that the droplets to be sprayed can be easily decelerated, and the droplets can be decelerated to the same flow velocity as the fine particles over a short distance. Accordingly, the fine particles and the droplets can be easily brought into contact with each other, and the fine particles can be more reliably collected by the droplets.

In the present embodiment, the nozzle 40 is disposed in a row-and-column arrangement in the two-dimensional direction. However, the nozzle 40 may be disposed in a zig-zag lattice pattern. Additionally, the droplet supply units 21c may be two-dimensionally arranged when viewed from the circulation direction 30, and may be disposed such that the positions thereof in the circulation direction 30 are shifted.

The present disclosure discloses the following invention. The following is not limited to the following.

(1) A dust collection system includes a circulation passage through which a gas circulates, a droplet supply unit that supplies droplets to the circulation passage, an electrostatic flocculation unit that is disposed in the circulation passage on a downstream side from a supply position of the droplets, forms an electric field in a flow path of the gas, charges fine particles contained in the gas and the droplets, and causes the fine particles and the droplets to collide with each other, and a dust collection unit that is disposed in the circulation passage on a downstream side from the electrostatic flocculation unit and collects the droplets and the fine particles.

(2) The dust collection system according to (1), in which the dust collection unit is an electric dust collector that has a discharge electrode and a ground electrode, forms an electric field between the discharge electrode and the ground electrode, and causes the droplets and the fine particles to adhere to the ground electrode.

(3) The dust collection system according to (2), in which the electrostatic flocculation unit forms an electric field having an electric field strength lower than that of the dust collection unit.

(4) The dust collection system according to (3), in which the electrostatic flocculation unit has an applied voltage smaller than that of the dust collection unit.

(5) The dust collection system according to (3) or (4), in which the electrostatic flocculation unit has a discharge electrode and a ground electrode, and a distance between the discharge electrode and the ground electrode is larger than that of the dust collection unit.

(6) The dust collection system according to any one of (2) to (5), in which the ground electrode is a plate-shaped electrode.

(7) The dust collection system according to any one of (2) to (5), in which the ground electrode is a rod-shaped electrode.

(8) The dust collection system according to any one of (1) to (7), in which the droplet supply unit supplies, to the circulation flow path, droplets in which a relationship between a flow rate α (L/min) of the droplets to be supplied and a gas flow rate β (m³/min) of the circulation flow path satisfies 0.1 (α/β)≤1.0.

(9) The dust collection system according to any one of (1) to (8), in which the droplet supply unit sprays the droplets to an upstream side.

(10) The dust collection system according to any one of (1) to (9), in which the droplet supply unit has spray ports that spray the droplets, the spray ports being arranged in a lattice pattern on a surface orthogonal to a flow direction of the gas.

(11) The dust collection system according to any one of (1) to (10), in which the droplet supply unit includes a mesh-shaped rectification mechanism on a downstream side of a spraying position where the droplets are sprayed.

(12) A dust collection method includes a step of supplying droplets to a circulation passage through which a gas circulates, a step of forming an electric field in the circulation passage on a downstream side from a supply position of the droplets, and charging fine particles contained in the gas and the droplets, a step of causing the fine particles and the droplets to collide with each other, and a step of collecting the droplets and the fine particles in the circulation passage on a downstream side from a position where the fine particles and the droplets are charged.

### REFERENCE SIGNS LIST

10: Combustion plant
12: Combustion device
14: Dust collection system
20: Circulation passage
21: Droplet supply unit
22: Electrostatic flocculation unit
24: Electric dust collector (Dust collection unit)
26: Blower
30: Circulation direction
40: Nozzle
50, 60: Discharge electrode
52, 62: Ground electrode
70, 72, 74: Particle distribution
82, 82a: Fine particle distribution
84: Droplet distribution
90: Fine particle
92: Droplet
94: First region
96: Second region

1. A dust collection system comprising:
a circulation passage through which a gas circulates;
a droplet supply unit that supplies droplets to the circulation passage;
an electrostatic flocculation unit that is disposed in the circulation passage on a downstream side from a supply position of the droplets, forms an electric field in a flow path of the gas, charges fine particles contained in the gas and the droplets, and causes the fine particles and the droplets to collide with each other; and
a dust collection unit that is disposed in the circulation passage on a downstream side from the electrostatic flocculation unit and collects the droplets and the fine particles,
wherein the dust collection unit is an electric dust collector that has a discharge electrode and a ground electrode, forms an electric field between the discharge electrode and the ground electrode, and causes the droplets and the fine particles to adhere to the ground electrode.

2. (canceled)

3. The dust collection system according to claim 1, wherein
the electrostatic flocculation unit forms an electric field having an electric field strength lower than that of the dust collection unit.

4. The dust collection system according to claim 3, wherein
the electrostatic flocculation unit has an applied voltage smaller than that of the dust collection unit.

5. The dust collection system according to claim 3, wherein
the electrostatic flocculation unit has a discharge electrode and a ground electrode, and a distance between the discharge electrode and the ground electrode is larger than that of the dust collection unit.

6. The dust collection system according to claim 1, wherein
the ground electrode is a plate-shaped electrode.

7. The dust collection system according to claim 1, wherein
the ground electrode is a rod-shaped electrode.

8. The dust collection system according to claim 1, wherein
the droplet supply unit supplies, to the circulation flow path, droplets in which a relationship between a flow rate α (L/min) of the droplets to be supplied and a gas flow rate β (m³/min) of the circulation flow path satisfies 0.1 (α/β)≤1.0.

9. The dust collection system according to claim 1, wherein
the droplet supply unit sprays the droplets to an upstream side.

10. The dust collection system according to claim 1, wherein
the droplet supply unit has spray ports that spray the droplets, the spray ports being arranged in a lattice pattern on a surface orthogonal to a flow direction of the gas.

11. The dust collection system according to claim 1, wherein
the droplet supply unit includes a mesh-shaped rectification mechanism on a downstream side of a spraying position where the droplets are sprayed.

12. A dust collection method comprising:
supplying droplets to a circulation passage through which a gas circulates;
forming an electric field in the circulation passage on a downstream side from a supply position of the droplets, and charging fine particles contained in the gas and the droplets;
causing the fine particles and the droplets to collide with each other; and
collecting the droplets and the fine particles in the circulation passage on a downstream side from a position where the fine particles and the droplets are charged.
